(19) United States
(12) Patent Application Publication
(10) Pub. No.: US 2002/0161724 A1
(43) Pub. Date: Oct. 31, 2002

(54) Enhanced protection for account-based transactions through the use of personal authorization criteria

(75) Inventor: Mark E. Peters, Chapel Hill, NC (US)

Correspondence Address: Gerald R. Woods, IBM Corporation T81/503, PO Box 12195, Research Triangle Park, NC, 27709, US

(73) Assignee: International Business Machines Corporation, Armonk, NY (US)

(21) Appl. No.: 09/827,075

(22) Filed: Apr. 5, 2001

(51) Int. Cl. H04K 1/00; H04L 9/00; G06F 17/60

(52) U.S. Cl. 705/72

(57) ABSTRACT

Account holders, such as credit or debit card holders, are sometimes concerned that information supplied to a merchant during transactions will be misappropriated and misused for fraudulent purposes. To improve the confidence of account holders that such misuse will not occur, an account holder may add merchant-specific personal authorization criteria to the account record. Criteria may also be established for controlling dealings with merchants for whom no explicit criteria exist.

### FIELD OF THE INVENTION

The present intention relates to commerce and more particularly to methods and systems for enhancing the security of account-based transactions through the use of personal authorization criteria.

### BACKGROUND OF THE INVENTION

The explosive growth of the Internet, and particularly the user-friendly World Wide Web, have created unprecedented opportunities for computer users to explore their world, retrieve information once relegated to the dusty shelves of distant reference libraries and to do more mundane things, like buy things. The World Wide Web has become a virtual Worldwide bazaar, offering products from the remote corners of the planet to shoppers who have to travel no further than the closest computer system with Internet access in order to learn about and buy such products. On perhaps a less exotic level, even staid, tradition-rich retailers have almost universally embraced the Internet and have begun to encourage their customers to use the World Wide Web to buy many products formerly available only at retail stores. Retailers with a Web presence stress the convenience of on-line shopping and are acutely aware that a well-designed Web site can effectively promote brand recognition and customer loyalty.

Because an on-line shopper and an on-line merchant do not engage in a face-to-face transaction, normal payment mechanisms such as personal checks or cash are seldom used for on-line transactions. By far, the bulk of on-line transactions are conducted using credit cards or debit cards as the payment mechanism. An on-line buyer sitting at a personal computer keyboard keys in critical account information, usually including the card identification, the name on the card, the card number and an expiration date. An on-line buyer using the telephone to contact a retailer provides the same information to the merchant's representative at the other end of the telephone connection.

A significant number of people refuse to shop on-line because they are concerned that the card information they must supply through a data network or over a telephone connection will find its way into the hands of criminals, who will use that information to make fraudulent purchases that will be billed to the card owner's account. While laws exist in some countries, including the United States, which limit the financial liability of a card owner for purchases made without the owner's consent, some people nevertheless are still reluctant to use credit or debit cards for on-line transactions. These people fear that, notwithstanding the laws, it will prove difficult and time-consuming to get fraudulent charges removed from their account records and that their credit rating and reputation will suffer damage even if they can ultimately show that they were not responsible for the charges.

Concerns such as those discussed above have led to the development of what are referred to as alternative payment options to enable shoppers to engage in on-line shopping without revealing credit card information. Alternative payment options, sometimes referred to as e-cash, generally conform to one of two major models. The more common of the two models is a stored-value model. According to this model, the user uses off-line transactions to create and maintain an on-line account with a particular merchant. The off-line transactions may consist of mailing a check to the merchant or presenting a credit card directly at a local establishment operated by the merchant or the merchant's agent in order to transfer funds into the on-line account. Once the on-line account is funded, the user can shop on-line with the merchant. The shopper provides a personal identification number known only to the shopper and the merchant to authorize the merchant to draw on the account.

The second e-cash model requires that a shopper establish an account with a third party willing to guarantee payment to a participating merchant. When a participating merchant fulfils an on-line order from the shopper, the merchant bills the third party, rather than the shopper. The third party then notifies the shopper of the account balance. To maintain the account, the shopper must pay off the balance on a regular basis. This e-cash model is very much like a normal credit card model but on a much smaller scale. The buyer's account information is more secure simply because there are fewer places at which a criminal can use that information to make fraudulent purchases.

A basic problem with e-cash models such as these is that participating merchants must do extra work to set up and use e-cash accounts. Relatively few merchants have been convinced they receive any substantial benefit from participating in e-cash programs, which means that there are relatively few places that shoppers with e-cash accounts can make use of them. This results in a chicken and egg situation with merchants being reluctant to participate in e-cash programs until more shoppers make use of them and shoppers being reluctant to join such programs until there are more merchants who are willing to participate in them. Another problem with e-cash models is that cardholders may not be able to repudiate a transaction if fraud occurs or if merchandise is misrepresented.

Still other payment mechanisms have been proposed which are intended to improve security for card holders while allowing merchants to use conventional card-based transaction authorization processes. According to one such mechanism, a buyer who wants to place an on-line order first provides notice of the proposed transaction to the card issuer or another agent to whom the responsibility for authorizing (or not authorizing) transactions has been delegated. For simplicity, institutions or agencies responsible for approving/disapproving on-line transactions in response to merchant requests are referred to as authorization agents. When notified of a proposed transaction by a card holder, the authorization agent responds by issuing a use-once-only surrogate number to the card holder. In the course of the following on-line transaction, the card holder uses the surrogate number in place of his regular account number. The merchant processes the surrogate card number in the conventional way, presenting the surrogate number to the authorization agent as part of its request for authorization. Because the surrogate number remains valid only for duration of the single transaction for which it was issued, it has no value to anyone who fraudulently acquires it for future use.

Under still another scheme, a card holder can turn his card “on” and “off”. The card holder is supposed to keep his card “off” or deactivated until he wants to use it in support of an on-line transaction. At that point, the card holder sends instructions to the authorization agent to turn the card “on”. Once the on-line transaction or transactions have been concluded, the card holder may expressly instruct the authorization agent to turn the card “off” or may simply wait for a time-out period to expire. The card will automatically be turned “off” on expiration of the time-out period. One potential problem specific to this scheme is that a diligent card holder may have completed a previous legitimate transaction before beginning the current transaction. If the card turns “off” as a result of the previous transaction before the merchant completes the authorization process for the current transaction, the possibility exists that authorization for the current transaction will be incorrectly withheld.

A more general problem with schemes such as the ones just discussed is the card holder must make an extra effort to provide advance notice to an authorization agent for each and every proposed on-line transaction. While some card holders may be willing to accept this burden, others will probably will find it to be annoying and frustrating, particularly if a communications problem keeps them from reaching the authorization agent when the shopper is ready to begin the on-line transaction.

### SUMMARY OF THE INVENTION

The present invention is a method and system for enhancing the security of an account by enhancing the control an account holder has over where and how the account can be used. An account is initially created in any of several conventional ways; for example, by an account candidate responding to direct mail or telephone solicitations by an account issuer. Once the account is established, however, the card holder has the option of creating his or her own credit authorization policy by providing personal authorization criteria to the authorization agent, who stores the criteria as part of the account record. In subsequent transactions, stored personal authorization criteria override any default authorization criteria normally followed by the authorization agent when receiving a request for authorization.

### BRIEF DESCRIPTION OF THE DRAWINGS

While the specification concludes with claims particularly pointing out and distinctly claiming that which is regarded as the present invention, details of preferred embodiments of the invention may be more readily ascertained from the following technical description when read in conjunction with the accompanying drawings wherein:

FIG. 1 is a block diagram of a conventional transaction system suitable for establishing the necessary relationships among participants in account-based transactions;

FIG. 2 is a block diagram of a transaction system showing the ordinary flow of information during account-based, such as those involving the use of credit or debit cards;

FIG. 3 is a block diagram of a transaction system showing both the ordinary flow of information and the added security-enhancing flow of information in accordance with the present invention;

FIG. 4 is a functional representation of a network system suitable for processing requests for conducting transactions in accordance with the present invention;

FIG. 5 is a block diagram of a computer system capable of implementing the presention invention;

FIG. 6 represents the data structure of an account record suitable for use in an implementation of the present invention;

FIG. 7 is a simplified flowchart of the basic method steps that are performed in implementing the present invention in a card-based transaction system; and

FIG. 8, consisting of FIGS. 8A and 8B taken together, is a more detailed flowchart of steps performed in the course of a request for authorization in a system implementing the invention.

### TECHNICAL DESCRIPTION

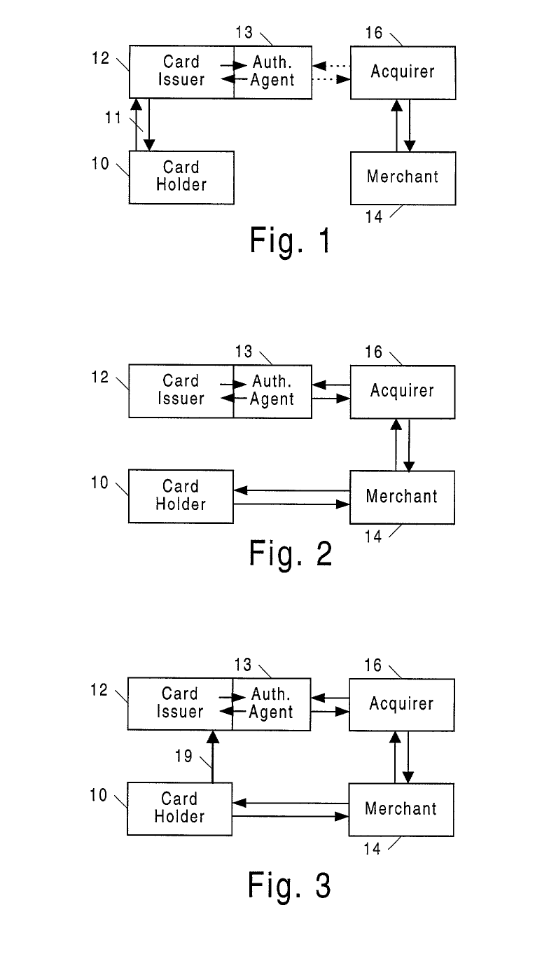

FIG. 1 is a block diagram showing the participants involved in almost any transaction involving an account established by a user. For the sake of simplicity, the participants are described in the context of a card-based system in which the user (or card holder) makes use of an account by means of a credit card or a debit card. These terms should not be construed as limiting the scope of the invention, which can be employed in any transaction system in which a user authorizes payments to be made from an existing account. The payments may be authorized by the presentation of credit/debit cards or written instruments such as checks, or by furnishing necessary account information orally or electronically. Before any transaction can be conducted a user 10 must establish an account with a card issuer 12 through an exchange 11 of information. The card issuer 12, typically a bank, is interested in receiving information bearing on the card holder's ability and willingness to make account payments. Assuming the card issuer 12 is willing to issue a card, it configures the account by establishing the account number, any Personal Identification Number (PIN), the applicable interest rate, the account limits, etc. and conveys this information back to the user 10, usually along with the card itself.

For an issued card to have value to the user (now card holder) 10, it must be accepted as a form of payment by a merchant 14 who has independently established a relationship (through an information exchange 15) with an acquirer 16 whose primary responsbility is to see that the merchant receives payments for authorized card transactions. The acquirer 16 is usually the banking institution with whom the merchant does his banking business. The acquirer 16, in turn, must have established a relationship with the card issuer 12, perhaps through an authorization agent 13. The authorization agent 13 may be an integral part of the card issuer's organization or may be a third party with whom the card issuer has contracted to perform the actual transaction authorization function. The information exchange required for establishing the relationship of the relationship between the acquirer 16 and card issuer 12 will probably bypass the authorization agent. When actual transaction information is processed, the acquirer 16 will almost always work directly with the authorization agent 13.

Referring to FIG. 2, once the account has been established, about the only further dialog between the card holder 10 and the card issuer 12 is the monthly presentation of an account statement by the card issuer 12 to the card holder 10 and the return of a payment on the account by the card holder 10. The card holder 10 deals directly with the merchant 14 by presenting either the card itself or account information to the merchant as a proposed form of payment for goods or services. The merchant passes the account information on to the acquirer for authorization of the transaction. Unless the acquirer happens to also be the card issuer, the acquirer in turn seeks approval of the transaction from the authorization agent 13, which is either part of or a representative of the card issuer 12. The authorization agent applies a standard set of criteria in deciding whether to authorize the transaction.

When the authorization agent 13 receives the transaction information from acquirer 16, the agent 13 performs certain standard processing operations which potentially will result in denial of authorization without going any further. For example, if the account information received from the merchant identifies a non-existent or closed account, authorization will immediately be denied. Assuming the standard processing operations are completed successfully, the agent 13 then accesses the account record associated with the received card number. Conventionally, the account record includes a credit limit and the amount of any unpaid charges already levied against the limit.

The authorization agent conventionally approves or disapproves the request for authorization depending on whether the proposed transaction satisfies default criteria, such as whether the proposed transaction will exceed the stated credit limit or will exceed an allowable transaction velocity; that is, a maximum number of transactions over a given period of time. The default criteria are established solely by the authorization agent and do not take any wishes or desires of a particular account holder into account.

The tenet which underlies the present invention is that no one knows better how a card holder uses or wants to use a credit or debit card than the card holder himself. This tenet is implemented using a system similar to that already described above. Referring to FIG. 3, the significant difference is that the card holder's interaction with the card issuer does not essentially end once the account is established. Instead, the card holder is empowered to impose personal authorization criteria (represented by arrow 19) on the card issuer, spelling out the conditions under which the card (or other account) can be used. These personal authorization criteria, which will be discussed in greater detail below, can be changed by the card holder from time to time and are binding on the authorization agent once they are accepted by the card issuer.

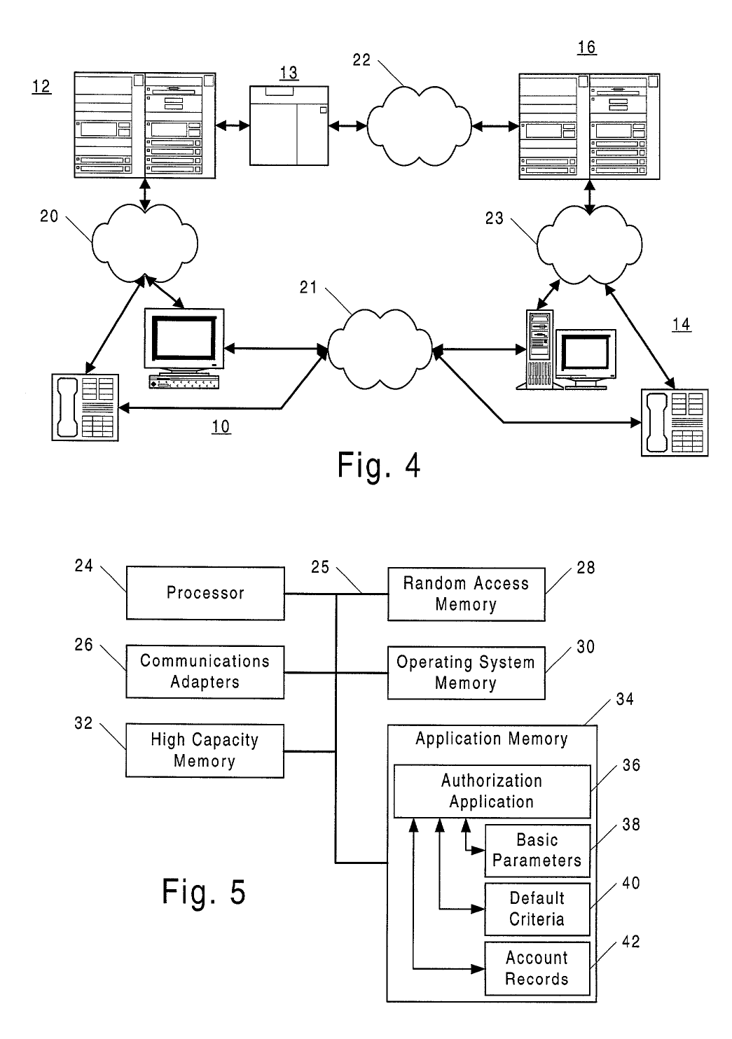

FIG. 4 illustrates the hardware and network components of a system in which the invention may be implemented. A card holder, using a personal computer 10a or perhaps a telephone 10b, initially establishes an account by communicating with a card issuer, represented as a computer system 12, through an intervening network 20, such as Public Switched Telephone Network (PSTN) or a data network. Once an account has been established, the user may use the same personal computer system 10a or telephone 10b to interact with a merchant through a merchant system 14a or merchant telephone system 14b. The network 21 connecting the user and the merchant may be a PSTN or a public data network such as the Internet. The merchant, in turn, interacts with the acquirer system through another network 23. Assuming the acquirer is a different entity than the card issuer, the acquirer interacts with the authorization agent 13 through still another set 22 of network connections. A system implementing the invention differs from a conventional system in the invention allows personal authorization criteria to be provided by the card holder to the authorization agent through the card issuer. Those criteria are then used by the authorization agent in deciding whether to approve or reject a received request for authorization.

The invention is not limited to systems of the type shown in FIG. 4. Instead of a conventional telephone or a conventional personal computer system, a user may interact with card issuers and merchants through Internet appliances, Internet-enabled wireless telephones, certain types of Personal Digital Assistants (PDA's) or any other kind of device capable of transmitting and receiving data.

FIG. 5 is a block diagram of a system suitable for the authorization agent system. A processor 24 communicates with remaining components of the system through an bus 25. The other components include one or more communications adapters 26 for allowing the authorization agent system to communicate with merchants and card issuers, random access memory 28 and a high capacity memory 32 for providing non-volatile store of data and programs. A number of technologies, including magnetic and optical technologies, may be employed for the high capacity memory. For purposes of the present invention, it is not important which of these technologies is used. For purposes of explaining the invention, the authorization agent system is also shown having an operating system memory 30 for storing the operating system which controls system operation and an application memory 34 for storing application programs to be executed under the control of the operating system. In practice, both the operating system and application programs being executed would likely be stored in random access memory and/or high capacity memory even during execution rather than in separate dedicated memories.

For purposes of the present invention, the application of interest stored in application memory 34 is a transaction authorization application 36 which processes proposed transactions received from acquirers through the communications adapters 26. The authorization application 36 would operate in accordance with a basic set of parameters 38 which, as noted earlier, will cause, among other things, a proposed transaction to be rejected if a nonexistent or invalid account is identified in the transaction information. The authorization application would also make use of a set 40 of default authorization criteria and a set of account records 42 which may contain personal authorization criteria provided by the account holder.

As noted earlier, a card account is normally established in a direct transaction between the card holder and the card issuer. Once the account is established, the card holder rarely deals directly with the card issuer or authorization agent, other than to make payments on the established account. In accordance with the present invention, however, the card holder is empowered to continue to deal directly with the card issuer (or authorization agent) through a direct link. The card holder can use the direct link to provide instructions to the authorization agent as to the conditions under transactions are to be approved. These conditions or personal authorization criteria are stored by the authorization agent as part of the account record.

While a wide variety of personal authorization criteria are possible, a logical dichotomy would be to have one or more sets of criteria for dealings with merchants with whom the card holder is already done business and a different set of criteria for dealings with all other merchants.

For merchants with whom the card holder has already done business, on a card-present and/or a card-not-present basis, the card holder knows whether there is a consistent pattern to the transactions that have already occurred with a particular merchant. If the card holder has a history of making frequent but small purchases from a particular merchant, the card holder may choose to establish personal authorization criteria for that merchant that would enable the authorization agent to approve only relatively small transactions but without regard for how frequently those purchases are made. If the card holder has a history of making relatively few, but high-value purchases from a different merchant, the card holder may choose to establish personal authorization criteria for that merchant which allows a limited number of high-value transactions to be approved over a given period of time. Potentially, a card holder could establish a unique set of authorization criteria for every merchant with whom he or she has done business in the past by identifying each merchant using some sort of merchant number or perhaps even the merchant's phone number and entering the merchant-specific authorization criteria.

The card holder has similar options available in establishing personal authorization criteria for classes of merchants for whom he or she does not wish to enter explicit criteria. For such merchants, the card holder decide to eliminate any risks by instructing the card issuer to never authorize an on-line transaction with any merchant for whom explicit personal authorization criteria have not already been established. Alternatively, the card holder may choose to allow the authorization agent to approve only relatively low-value transactions, possibly with a relatively low limit on the number of any such transactions that will be approved over a given period of time.

Card holders may also choose to establish personal authorization criteria which prevent online or card-not-present transactions from being authorized for merchants outside the card holder's home country. Similarly, the card holder may set up personal criteria which prevent the account from being used to pay for “adult” merchandise or for telephone calls of the type where the called party dispenses psychic advice or “adult” conversation while charging the card account significant amounts per minute of off-hook time.

If a card holder has already personal authorization criteria in mind when the account is initially established, the criteria may be entered and recorded as part of the account setup operation. As the card holder develops or changes his personal authorization criteria for particular merchants, he can contact the card issuer or authorization agent whenever necessary to add new criteria or revise existing criteria. Giving the card holder the power to alter existing criteria makes it possible for the card holder to preauthorize a particular purchase that falls outside the scope of preexisting personal authorization criteria. If the card holder knows that only one such purchase will occur, a parameter may be entered which will cause the preexisting criteria to be restored once the purchase is complete.

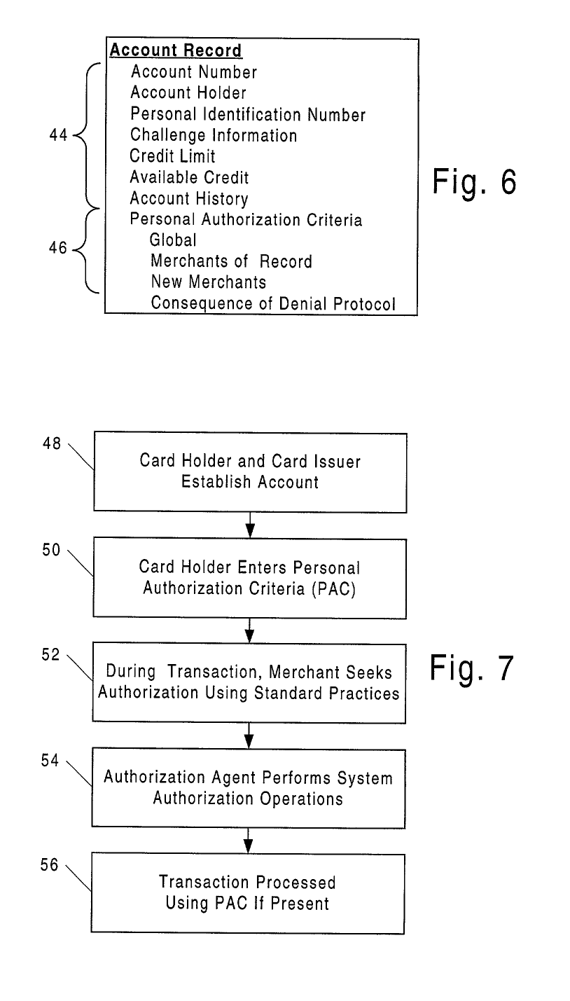

Regardless of the details of the authorization criteria provided by the card holder, those criteria will become part of an account record having the general structure shown in FIG. 6. The account record will include a set 44 of standard account information including the account number, the identity of the account holder, a personal identification number, and challenge information which the card holder may use to obtain either the same or a new personal identification number if the card holder loses or forgets the old one. The standard account information will typically also include the credit limit, the amount of credit currently available, and other account information or history which the authorization agent considered worth maintaining.

In systems implementing the present invention, the account record will also include a set 46 of personal authorization criteria established under the control of the card holder. The personal authorization criteria may include global criteria applicable to all merchants, sets of criteria applicable to explicitly identified merchants (that is, merchants of record), and sets of criteria applicable to merchants for whom no explicit criteria has been entered (that is, new merchants). It should be noted that the term “new merchants” as used here can include not only merchants with whom the card hold has never done business as well as merchants with whom the card holder has done business in the past but for whom no merchant-explicit personal authorization criteria have been entered.

The set 46 of information may also include instructions as to what should happen if the authorization agent disapproves a proposed transaction. Such instructions are identified in the drawings as a Consequences of Denial protocol and will spell out the steps the card holder wants the card issuer to take following a denial. A conservative card holder may want the card issuer to “freeze” the account following any denial for any reason. A less conservative card holder may conclude there is no reason to freeze the account if the denial was for some relatively innocuous reason, such as the transaction would have caused the credit limit to be exceeded.

The Consequences of Denial Protocol may also spell out the conditions for notifying the card holder of a denial. The card holder may agree that notification of the denial and reasons for it can be provided through the merchant or directly via telephone contact, e-mail, separate letter or (for trivial denials) only as part of the next statement received from the card issuer. One advantage of allowing the merchant to provide immediate feedback of a notice of denial is that the card holder would have the immediate opportunity to revise the personal authorization criteria in a way that would allow the transaction to continue. For obvious security reasons, the card holder would be likely to perform the revision in a separate session with the card issuer or authorization agent.

FIG. 7 is a flowchart of basic method steps that are performed in carrying out the present invention. Some of these steps have already been described but will repeated here for the sake of completeness. In an initial step 48, the card holder and the card issuer perform the steps needed to initially establish the card account, including any credit limit and any system-level criteria which the authorization agent will employ without regard to whether personal authorization criteria have been established. Personal authorization criteria will be provided by the card holder to the card issuer or authorization agent in one or more iterations of a step 50. As noted earlier, personal authorization criteria may be entered when the account is established or later at the discretion of the card holder.

When the card (or account information) is used during a later transaction, the merchant to whom it is presented requests authorization (operation 52) for the transaction in the conventional way. The merchant will neither know nor care whether the card holder has provided personal authorization criteria specific to the requesting merchant. When the request for authorization is received, the authorization agent performs system-level operations 54 (e.g., is there a valid account) before attempting to recover account-specific information, Assuming the request for authorization survives the system-level checks, the authorization agent then retrieves the account record for the relevant account, determines whether the account contains personal authorization criteria, and processes the transaction accordingly in operation 56. If the card holder has entered personal authorization criteria, the transaction is processed using the recorded criteria. If no personal authorization criteria is found, the card issuer applies standard or default criteria in deciding whether to approve the transaction.

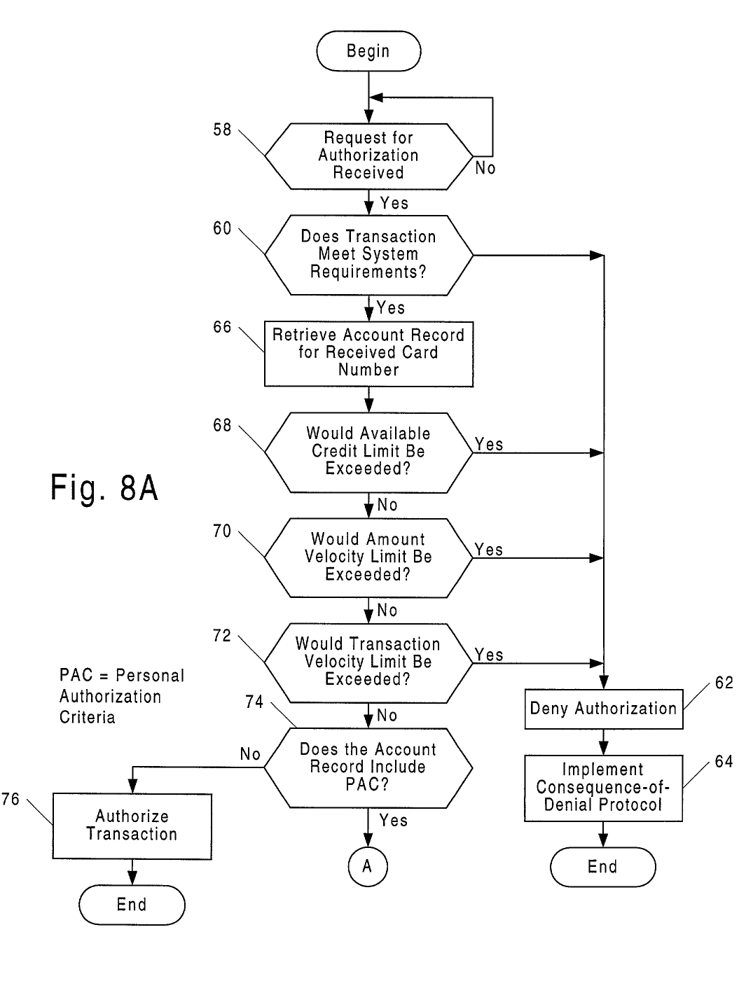

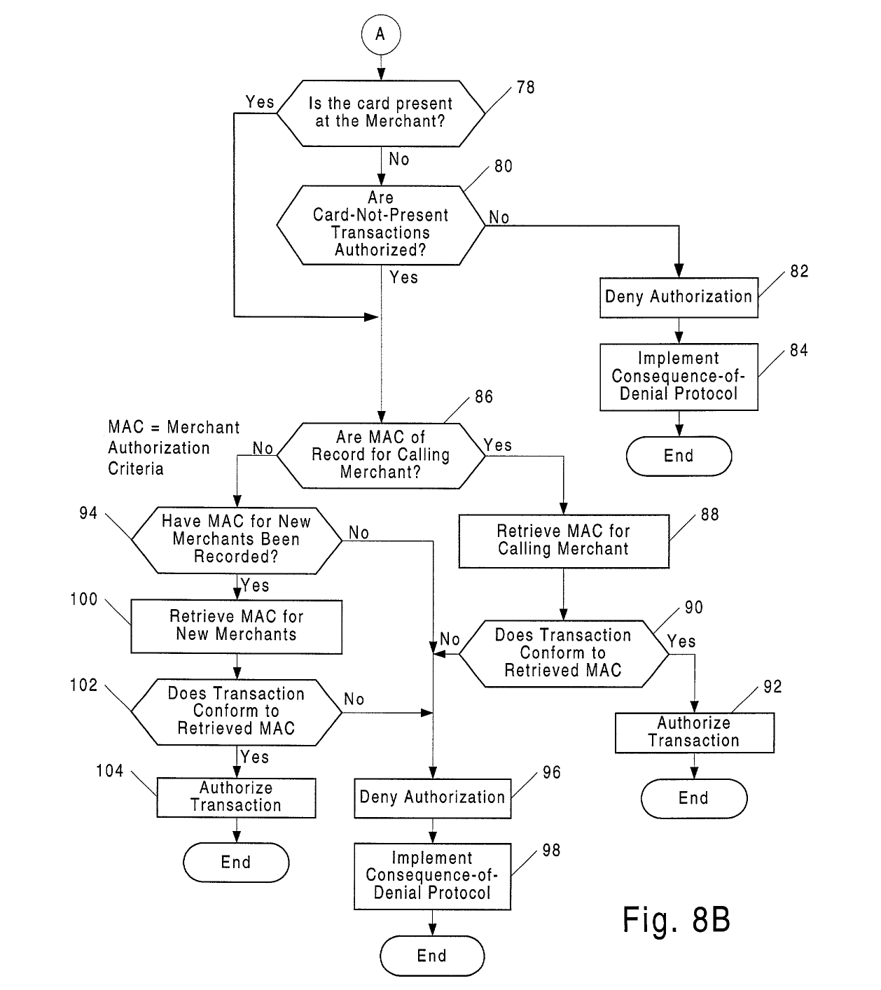

FIG. 8 is a more detailed flowchart of steps that may be performed by an authorization agent in executing a preferred implementation of the present invention. The method is initiated in step 58 when a request for an authorization is received. System-level tests 60 are performed. If the request fails those tests, the request is denied in a step 62 and any existing system-level Consequences-of-Denial protocol is implemented in a step 64. Assuming the request survives the system-level tests, the appropriate account record is identified in step 66 using information received in the request for authorization. Once the account is identified and the account record is retrieved, the card issuer tests the proposed transaction against a set of globally applicable criteria. The global criteria will generally always include a test 68 whether the proposed transaction will cause the credit limit of the identified account to be exceeded, may include a test 70 whether the proposed transaction will a monetary velocity limit (maximum amount chargeable over a given period of time) to be exceeded and/or a test 72 whether the proposed transaction will cause a numeric velocity limit (maximum number of transactions allowed over a given period of time) to be exceeded. If any of these checks yields a positive result, the request for authorization of the proposed transaction is denied in operation 62 and any existing account-level consequence-of-denial protocol is implemented.

Assuming that all the global tests are satisfied, the next step in the method is a check 74 whether the account contains any personal authorization criteria. If no such criteria is found, the proposed transaction is authorized in step 76. However, if the account does contain personal authorization criteria, the proposed transaction is tested against such criteria beginning with a check 78 of whether the merchant requesting authorization has actually seen the credit card; that is, whether the card holder and the merchant are engaged in a face-to-face transaction or a remote transaction.

A card holder may decide that he or she the card to be used only for face-to-face transactions, making that one of the personal authorization criteria provided to the card issuer. If the card holder has done that and if the merchant has not seen the card, a test 80 will yield a negative result which will result in denial of authorization in step 82. Any consequence-of-denial protocol specified by the card holder will be implemented in step 84.

If the merchant has seen the card or card holder has authorized at least some card-not-present transactions, the next step 86 is a determination whether any personal authorization criteria specific to the calling merchant are of record in the account information. For simplicity, personal authorization criteria specific to a particular merchant is identified as MAC or Merchant Authorization Criteria. If MAC exist for the calling merchant, they are retrieved in step 88. The proposed transaction is tested against the retrieved MAC in step 90. If the transaction conforms, it is authorized in step 92. If the transaction does not conform to the retrieved MAC, the request for authorization is denied in step 96 and any specified consequence of denial protocol is implemented in step 98.

If the test performed at step 86 does not find any MAC for the calling merchant, a check 94 is made as to whether the account record includes instructions or criteria for dealing with other merchants. If no such instructions are found, authorization is denied in step 96 and any specified personalized consequence-of-denial protocol is implemented in step 98.

If the card holder has provided instructions for dealing with merchants for whom no MAC records exist, those instructions are retrieved in step 100 and used to test the proposed transaction in step 102. If the proposed transaction fails any of the tests, the request for authorization is denied. If the proposed transaction satisfies all criteria provided by the card holder, the transaction is authorized in step 104.

A significant advantage of the present invention is that it imposes no constraints on how the card holder elects to do business with merchants, on how merchants do business with acquirers or on how acquirers do business with authorization agents. Similarly, it does not require that a card holder be limited to using a personal computer system to enter personal authorization criteria. The card holder may use an Internet enabled telephone or even a conventional telephone to provide the criteria to the card issuer through a public telephone network connection.

In fact, as noted earlier, there is no requirement that the invention be limited to remote transactions. The value of the system even for face-to-face transactions is apparent in the description of FIG. 8 above. Finally, while most of the discussion has been in terms of use of credit or debit cards, the invention has value for different kinds of accounts, including conventional checking accounts and so-called positive-pay accounts.

While there have been described what are considered to be preferred embodiments of the invention, variations and modifications in those embodiments will occur to those skilled in the relevant part. Therefore, it is intended that the appended claims shall be construed to include both the preferred embodiments and all variations and modifications that fall within the true spirit and scope of the invention.

What is claimed is:

1. A method for enhancing the security of account-based transactions comprising the steps of:
receiving a request for authorization from a merchant, the request for authorization including at least an account number and the amount of the transaction;
identifying an account record associated with the received account number;
determining whether the account record includes personal authorization criteria provided previously by the owner of the identified account; and
using available personal authorization criteria to process the request for authorization.

2. A method as set forth in claim 1 wherein the using step further includes the steps of:
processing the request for authorization in accordance with any available personal authorization criteria relating to merchant-independent properties of the transaction;
where the request cannot be processed using only personal authorization criteria relating to merchant-independent properties of the transaction, processing the transaction in accordance with any available merchant-specific criteria, otherwise determining whether the account record contains personal authorization criteria for dealing with authorizations requested by previously-unidentified merchants; and
where criteria are found dealing with previously-unidentified merchants, processing the request for authorization in accordance with said criteria.

3. A method as set forth in either claim 1 or claim 2 further including the steps of:
denying the request for authorization where the transaction fails to comply with applicable criteria;
implementing a consequence-of-denial protocol upon denial of the request, said protocol specifying the actions to be taken upon denial.

4. A method as set forth in claim 3 further including the step of notifying the account owner of the denial of authorization in accordance with notification requirements set forth in the consequence-of-denial protocol.

5. A method as set forth in claim 4 wherein the personal authorization criteria relating to properties of the transaction includes criteria relating to the location of merchants for whom transactions may be authorized.

6. A method as set forth in claim 4 wherein the personal authorization criteria relating to properties of the transaction includes criteria relating to classes of goods or services for which transactions may be authorized.

7. A method for enhancing the security of account-based transactions comprising the steps of:
receiving a request for authorization from a merchant, the request for authorization including at least an account number and the amount of the transaction;
identifying an account record associated with the received account number;
determining whether the account record includes personal authorization criteria provided previously by the owner of the identified account;
where personal authorization criteria relating to merchant-independent properties of the transaction is found, processing the request in accordance with such criteria;
where no criteria relating to merchant-independent properties of the transaction is found or the request cannot be processed using only personal authorization criteria relating to merchant-independent properties of the transaction, processing the transaction in accordance with any available merchant-specific criteria, otherwise determining whether the account record contains personal authorization criteria for dealing with authorizations requested by previously-unidentified merchants;
where criteria are found dealing with previously-unidentified merchants, processing the request for authorization in accordance with said criteria; and
where transaction authorization is denied, determining whether the account record includes a consequences-of-denial protocol and implementing any such protocol found.

8. A system for enhancing the security of account-based transactions comprising:
a communication system for receiving a request for authorization from a remote merchant, the request for authorization including at least an account number and the amount of the transaction; and
an authorization system comprising
a computer system for identifying an account record associated with the received account number, determining whether the account record includes personal authorization criteria provided previously by the owner of the identified account, and retrieving any authorization criteria stored as part of the account record, and
a transaction processing system responsive to the presence of personal authorization criteria to process the request for authorization in accordance with said criteria, said transaction processing system being responsive to the absence of personal authorization criteria to process the request for authorization in accordance with previously established default criteria.

9. A system as set forth in claim 8 wherein the personal authorization criteria includes criteria specific to particular merchants.

10. A system as set forth in claim 9 wherein the personal authorization criteria further includes criteria to be observed where the merchant requesting authorization is not the subject of merchant-specific criteria.

11. A method of enhancing the security of account-based transactions comprising:
storing default criteria for processing requests for authorization;
establishing an account record for a particular account number;
storing personal authorization criteria provided by the owner of the account in the account record; and
processing requests for authorization in accordance with stored personal authorization criteria; otherwise processing such requests in accordance with stored default criteria.
